(19) United States
(12) Patent Application Publication
(10) Pub. No.: US 2009/0022536 A1
(43) Pub. Date: Jan. 22, 2009

(54) SOUND BASED MEDIA DRIVE

(75) Inventors: Kent S. Takeshita, Eagle, ID (US); Clyde A. Johnson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/779,870

(22) Filed: Jul. 18, 2007

(51) Int. Cl. B41J 11/04

(52) U.S. Cl. 400/617

(57) ABSTRACT

Various methods and apparatus relating to sensing sounds of a medium being driven and to adjusting driving of the medium as the medium is being driven based upon the sensed sounds are disclosed.

### BACKGROUND

Media sometimes jams as it is being driven in a printer or other media handling device. Removal of the jammed media is often difficult and time-consuming.

### BRIEF DESCRIPTION OF THE DRAWINGS

FIG. 1 is a fragmentary sectional view the schematically illustrating a media handling device according to an example embodiment.

FIG. 2 is a flow chart illustrating an example method for adjusting driving of a medium as the medium is being driven based upon sensed sound according to an example embodiment.

### DETAILED DESCRIPTION OF THE EXAMPLE EMBODIMENTS

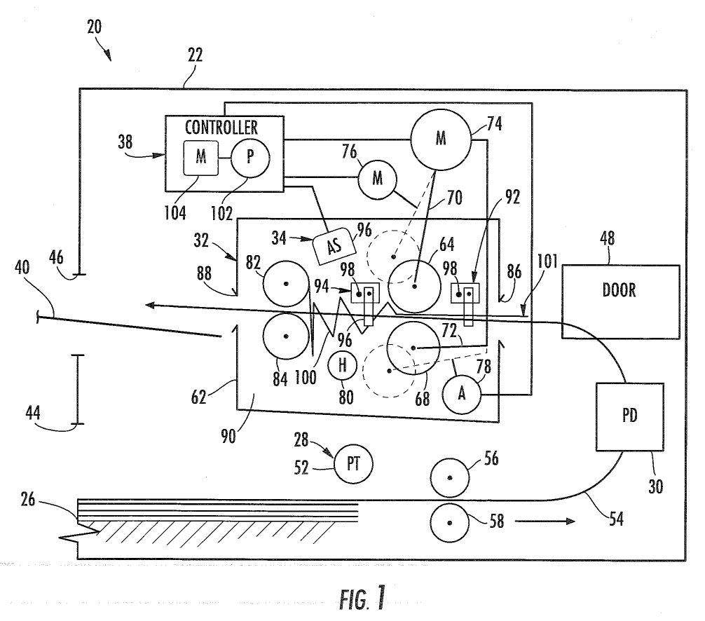

FIG. 1 schematically illustrates a media handling device 20 according to an example embodiment. As will be described hereafter, media handling device 20 is configured to adjust the driving of a medium based upon sensed sounds of the device 20 as a medium is being driven. In the example illustrated, media handling device 20 is configured to detect a beginning of a media jam and to adjust driving of the medium yet while the medium is being jammed to facilitate subsequent clearing of the jam.

In the particular example illustrated, media handling device 20 comprises a printer configured to print upon a medium. In the example illustrated, media handling device 20 is configured to drive individual sheets of media. In other embodiments, media handling device 20 may comprise other vices configured to handle and transport media for alternative or additional operations upon the media such as folding, creasing, collating, stapling or scanning. In other embodiments, the media may alternatively be in the form of a roll.

In the example embodiment shown in FIG. 1, media handling device 20 includes housing 22, media input 26, media transport 28, print device 30, media heating system 32, detection system 34, controller 38 and output 40. Housing 22 comprises one or more structures at least partially surrounding a majority if not all of the remaining components of media handling system 20. As schematically shown in FIG. 1, housing 22 includes an opening 44 adjacent to input 26 and an opening 46 adjacent output 40. Housing 22 further includes one or more doors 48 (schematically shown) located and configured such that when the one or more doors 48 are opened or removed, access through housing 22 is provided to an input side of media heating system 32. Opening or removal of door 48 permits the user to grasp a trailing edge of a medium that may be partially jammed within media heating system 32 to remove the partially jammed medium.

In one embodiment, door 48 may serve additional purposes as well. For example, in one embodiment in which print device 30 includes a removable supply of printing material, door 48 and additionally provide access for insertion of the removable printing material supply. In one embodiment, the removable printing material supply may comprise an electrophotographic or laser toner cartridge with may also include a photoconductive drum and/or a transfer roller. Door 48 may permit insertion of such a cartridge in addition to providing access to interior of the handling device 20 for clearing media jams.

Media input 26 comprises one or more structures by which media is loaded or otherwise supplied to media handling device 20. In the particular example illustrated, media input 26 comprises a tray, bin or other storage structure configured to contain and support a stack of sheets of media. In other embodiments, media input 26 may have other configurations.

Media transport 28 comprises one of more structures and/or mechanisms configured to transport media from media input 26 to print device 30, to media heating system 32 and to output 40. In the example illustrated, media transport 28 includes pick tire 52, media path 54 and transport rollers 56, 58. Pick tire 52 comprises a rotationally driven member configured to frictionally engage a face of a sheet of media and to transfer the engaged sheet further along media path 54 to one or more downstream rollers 56, 58. Although pick tire is illustrated as being located so as to engage a top sheet of a stack of media on input 26, and other embodiments, pick tire 28 may be configured to engage a bottommost sheet of the stack.

Media path 54 comprises one of more structures which define a path along which picked sheets of media are driven to print device 30, media heating system 32 and to output 40. Media path 54 may comprise stationary panels, walls or other structures which guide movement of the driven sheets. Media path 54 may additionally include actuatable diverters. In addition, media path 54 may include one or more pairs of undriven rollers. Although media path 54 is illustrated as having a U shaped path, facilitating a front-load front-output architecture for media handling system 20, in other embodiments, media path 54 may have a linear path or may have other configurations.

Transport rollers 56, 58 (schematically represented) comprise one or more pairs of opposing rollers situated along media path 54 and configured to drive a medium along media path 54. At least one roller 56, 58 of each pair of rollers is operably coupled to a source of torque (motor) by a transmission so as to be rotationally driven. In some embodiments, both of rollers 56, 58 may be rotationally driven. In other embodiments, one of rollers 56, 58 of each pair of rollers may alternatively idle.

Print device 30 comprises a device configured to deposit printing material upon at least one face of a medium to form an image (text or graphics) upon the medium. In the example embodiment illustrated, print device 30 comprises an electrophotographic print device in which toner is applied to a medium. In such an embodiment, electrostatically charged toner is applied to an electrostatic image and subsequently transferred to the medium.

Media heating system 32 comprises an arrangement of components or structures generally within housing 22 of media handling system 20 that are configured to heat the media and the applied printing material. In the particular example illustrated, media handling system 20 comprises an electrophotographic printer and media heating system 32 comprises a fuser configured to fuse toner applied on the medium. In another embodiment in which print device 30 comprises a drop-on-demand inkjet print device, system 32 is configured to apply heat to the wet ink.

Media heating system 32 includes an enclosure 62, rollers 64, 66, transmissions 70, 72, motor 74, actuators 76, 78, heater 80 and rollers 82, 84. Enclosure 62 comprises one more structures surrounding and enclosing roller 64, 66, heater 80 and rollers 82, 84. Enclosure 62 includes input 86 and output 88. Enclosure 62 forms an interior chamber 90 between input 86 and output 88 through which media is moved and is heated prior to being discharged through opening 46. Enclosure 62 retains heat about the medium. In other embodiments, enclosure 62 may be omitted.

Roller 64, 66, transmissions 70, 72, motor 74 and actuators 76, 78 cooperate to drive a sheet or medium along media path 54 within enclosure 62 as the heat is applied to the medium. The applied heat or other factors sometimes cause the sheet or medium to jam within enclosure 62. Rollers 64, 66, transmissions 70, 72, motor 74 and actuators 76, 78 further facilitate adjustment or modification of the driving of the medium upon initial detection of the beginning of a jam. As will be described hereafter, such adjustment is made in response to sounds sensed by detection system 34.

In the particular example illustrated, rollers 64, 66, transmissions 70, 72, motor 74 and actuators 76, 78 provide multiple ways of adjusting the driving of a sheet of media in response to a detected initiation of a jam. As will be described hereafter, such adjustments include (1) rotationally driving one or both the roller 64, 66 in a reverse direction to drive a medium towards input 86, (2) ceasing the transmission of torque to one or both of rollers 64, 66 either by stopping the supply of torque from motor 74 or by interrupting the transmission of torque along one or both of transmissions 70, 72 and (3) moving one or both the roller 64, 66 out of frictional driving engagement with an intermediate medium or sheet. Interrupting the transmission of torque or moving one or both of the rollers 64, 66 may be performed either by motor 74 supplying torque in an opposite direction or by use of one or both of actuators 76, 78. In one embodiment, such adjustments may be combined and performed in response to detection of the initiation of a jam. In other embodiments, media handling system 22 is configured to permit an operator to select which of such multiple available adjustments or combinations of adjustments are to be performed in response to detection of the initiation of a jam. In still other embodiments, one or more of transmissions 70, 72 or actuators 76, 78 may have different configurations, wherein less than all of the noted adjustment options may be available.

Rollers 64, 66 comprise a pair of opposing rollers arranged so as to engage opposite faces of a medium. In the example illustrated, rollers 64, 66 engage opposite faces of a medium that has been printed upon. In the embodiment illustrated in which heating system 32 is employed in an electrophotographic printer, rollers 64, 66 cooperate to apply pressure to the toner to assist in fusing the toner to the medium. At least one of rollers 64, 66 is rotationally driven. In the particular example illustrated, both of rollers 64, 66 are rotationally driven. In the example illustrated, roller 64 comprises a pressure roller while roller 66 comprises a heated fuser roller. According to one embodiment, roller 66 is internally heated. In other embodiments, roller 66 may be externally heated or heated in other fashions. In yet another embodiment, roller 66 may not be heated.

Transmissions 70, 72 comprise an arrangement of one of more components configured to transmit torque or motion from motor 74 to rollers 64, 66, respectively. In one embodiment, transmissions 70, 72 may comprise a gear train. In other embodiments, transmissions 70, 72 may comprise other torque or motion transmitting arrangements such as belt and pulley arrangements or chain and sprocket arrangements. Torque or motion transmitted by transmissions 70, 72 rotationally drives rollers 64, 66. In embodiments where one of rollers 64, 66 is rotationally driven (wherein the other roller idles or merely rotates as a result of media being driven against the undriven roller), the transmission associated with the undriven roller may be omitted.

According to one embodiment, transmissions 70, 72 may be configured to actuate between a transmitting state transmitting output of motor 74 (torque) to rollers 64, 66, respectively, and a non-transmitting state. In one embodiment, transmission 70, 72 may actuate to the transmitting state in response receiving torque from motor 74 in a first direction and may actuate to the non-transmitting state in response to receiving torque from motor 74 in a second opposite direction using one or more ratchet or clutch mechanisms. In yet another embodiment, transmissions 70, 72 may actuate between the transmitting state and the non-transmitting state in response to being actuated by actuators 76, 78, respectively.

In yet another embodiment, transmissions 70, 72 may be configured to transmit output from motor 74 to rollers 64, 66 and to maintain roller 64, 66 in engagement with opposite faces of a medium in response receiving torque from motor 74 in a first direction while also being configured to move rollers 64, 66 away from one another and out of driving engagement with a medium (as shown in broken lines) in response to receiving torque from motor 74 in a second opposite direction. In yet other embodiments, transmissions 70, 72 may be maintained in a single fixed state in which torque is transmitted to rollers 64, 66, respectively.

In particular embodiments, one of transmission 70, 72 may be stationary while the other of transmissions 70, 72 is configured as noted above (1) to actuate between a transmitting state and a non-transmitting state based on the direction which torque is applied or in response to being actuated by an actuator 76, 78 or (2) to move the associated roller 64, 66 towards or away from the medium and the opposing roller based on the direction which torque is applied or in response to being actuated by an actuator 76, 78. In other embodiments, both of transmissions 70, 72 may be stationary. Furthermore, as noted above, in embodiments where only one of rollers 64, 66 is rotationally driven, the transmission associated with the undriven roller may be omitted.

Motor 74 comprises a source of torque or motion for driving one or more of rollers 64, 66. According to one embodiment, motor 74 comprises a bi-directional motor. In yet other embodiments, motor 74 may be configured to supply torque in a single direction. Although system 32 is illustrated as rotationally driving both rollers 64 and 66 using torque from a single motor 74, in other embodiments, rollers 64, 66 may be rotationally driven with separate and distinct motors.

Actuator 76, 78 comprise mechanisms configured to actuate transmission 70, 72 and/or rollers 64, 66, respectively, to adjust driving of media. In one embodiment, actuators 76, 78 are configured to selectively move or engage portions of transmission 70, 72 to actuate transmission 70, 72 between the above noted transmitting and non-transmitting states. In other embodiments, actuators 76, 78 are configured to move or actuate transmission 70, 72 and/or roller 64, 66 such a move roller 64, 66 away from one another out of frictional driving engagement with an intermediate medium.

In one embodiment, actuators 76, 78 may comprise electric solenoids, hydraulic or pneumatic piston-cylinder assemblies, or other motor driven or mechanical actuation mechanisms. In particular embodiments where only one of transmission 70, 72 is actuated between a transmitting state and a non-transmitting state or where only one of rollers 64, 66 is moved out of driving engagement with a medium, one of actuator 76, 78 may be omitted. In some embodiments, both of actuator 76, 78 may be omitted where adjustment of the driving of a medium is performed in other manners.

Heater 80 comprises a mechanism within enclosure 62 configured to heat roller 66 and/or a medium or sheet as it passes through enclosure 62. In one embodiment, heater 80 may comprise an infrared heater or other heating mechanism. Heater 80 may apply supplemental heat in addition to the heat applied by roller 66. In other embodiments, heater 80 may supply the only heat within enclosure 62. In yet other embodiments, heater 80 may be omitted.

Rollers 82, 84 comprise second pair of opposing rollers located downstream from roller 64, 66 along media path 54. At least one of rollers 82, 84 is rotationally driven by motor 74 (via a transmission not shown) or by another motor and transmission (not shown). Rollers 82, 84 engage opposite sides of the medium to continue driving the medium. In the example illustrated, rollers 82, 84 are located so as to discharge the medium through output 88. In other embodiments, media heating system 32 may include additional pairs of such rollers along media path 54. In some embodiments, rollers 82, 84 may be omitted.

Detection system 34 comprises an arrangement of components configured to detect the movement or interruption of movement of a sheet or medium along media path 54. Detection system 34 comprises sensors 92, 94 and audio sensor 96. Sensors 92, 94 are configured to sense positioning of a sheet or medium along path 54 within enclosure 62. Sensor 92 senses entry of a sheet through input 86. Sensor 94 senses movement of a sheet past rollers 64, 66. In the embodiments illustrated, signals from one or both of sensors 92, 94 may be used to adjust a rate at which audio sensor 96 is polled by controller 38 or when the sensed sound is compared to stored values.

In the example illustrated, each of sensors 92, 94 comprise flag sensors including a flag 96 and a photodetector 98. Flag 96 is configured to pivot or otherwise move upon being engaged by a sheet of medium. Movement of the flag 96 either interrupts or is moved out of interruption with optical detector 98. In other embodiments, sensors 92, 94 may have other configurations or may be omitted. In particular embodiments, sensors 92, 94 may additionally be used to further confirm the existence of a media jam based on the time at which a sheet is in engagement with a flag 96 of one or both of sensors 92, 94.

Audio sensor 96 comprises one or more transducers or microphones located and configured to sense sounds emanating from interior portions of enclosure 62 or from locations proximate to rollers 64, 66, such as between roller 64, 66 and rollers 82, 84. Detection system 34 is configured to sense sounds which occur when a sheet or medium is beginning to jam, crumple or otherwise assume an irregular shape within enclosure 62 or between roller 64, 66 and rollers 82, 84. FIG. 1 illustrates a sheet or medium 100 undergoing an accordion media jam in which medium 100 crumples, folds or collapses within the space or volume between roller 64, 66 and rollers 82, 84and cannot travel further along media path 54, beyond rollers 82, 84 or through output 88. Signals from audio sensor 96 are used by controller 38 to adjust driving a sheet of media such that driving of media 100 is either stopped or reversed prior to the trailing edge 101 of medium 100 passing through opening 86 or between the nip between roller 64, 66 which would otherwise inhibit or prevent manual dislodgment or removal of the jammed medium 100.

Controller 38 comprises one or more processing units and associated memory configured to receive signals from audio sensor 96 emanating from movement of a sheet of media and to adjust driving of the same sheet of media automatically while the same sheet of media is being driven based upon the sensed sounds. In the example illustrated, controller 38 includes processing unit 102 and memory 104. For purposes of this application, the term “processing unit” shall mean a presently developed or future developed processing unit that executes sequences of instructions contained in a memory, such as memory 104. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 38 may be embodied as part of one or more application-specific integrated circuits (ASICs). Unless otherwise specifically noted, the controller is not limited to any specific combination of hardware circuitry and software, nor to any particular source for the instructions executed by the processing unit.

Processing unit 102 determines whether adjustments are to be made to the driving of a sheet of media along media path 54 using signals or sensed sound values from audio sensor 96. Processing unit of 102 determines whether a media jam is beginning such that corrective adjustments may be made to the driving of the media prior to completion of the jam or prior to a trailing edge of the medium entering input 86 and passing through input 86. As a result, a person, opening door 48, may access the trailing edge of the medium and manually pull the partially jammed or crumpled medium from enclosure 62.

According to one embodiment, processing unit 102, following instructions contained in the computer readable medium of memory 104, compares the sensed sound that it receives with an audio signature or pattern previously recorded during the beginning or initiation of an actual previous media jam and stored in memory 104 or otherwise provided. For example, processing unit 102 may compare the amplitudes, frequencies of changes and other digital or analog sound characteristics. When the sensed sound is sufficiently close to the stored audio signature representing the beginning of a media jam, processing unit 102, following instructions contained in memory 104 automatically generates control signals adjusting the driving of a sheet of media. Because such adjustments are made automatically and without user intervention, such adjustments may be made in a sufficiently short period of time to reduce the likelihood of completion of the jam and to facilitate removal of the jam by the user of media handling device 22.

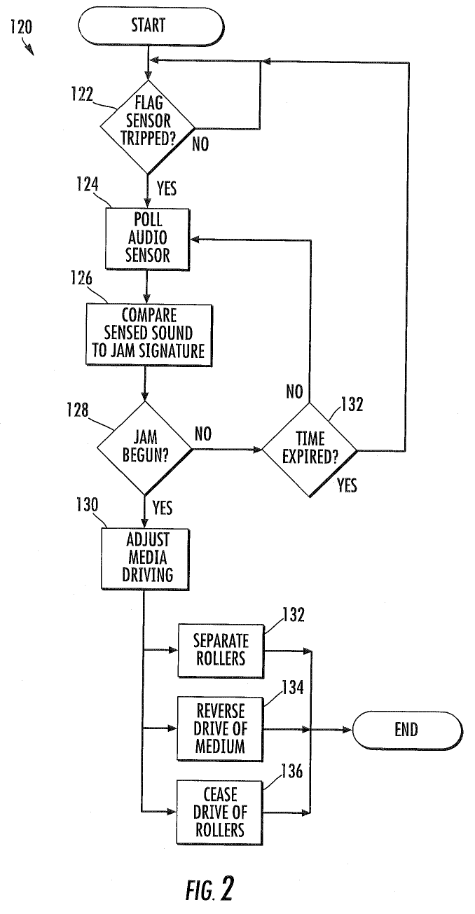

FIG. 2 is a flow diagram illustrating one example method 120 for identifying the beginning of a media jam and for adjusting driving of media to lessen the severity of the jam. For ease of discussion, the following describes method 120 as being carried out by media handling device 20. In other embodiments, method 120 may be performed with other media handling devices.

As indicated by step 122, controller 38 receives signals from sensor 92. Controller 38, following instructions contained in computer readable medium of memory 104, determines when sensor 92 has been tripped, i.e., when a sheet of media has entered input 86 and has pivoted flag 96 so as to either interrupt optical detector 98 or to move out of interruption of optical detector 98. Alternatively, controller 38 may determine when sensor 94 has been tripped, when the sheet of media has moved past rollers 64, 66 and is between roller 64, 66 and output 88.

As indicated by step 124, in response to receiving signals indicating that sensor 92 (and/or sensor 94) has been tripped, controller 38 adjusts its polling of audio sensor 96. In one embodiment, controller 38 does not poll audio sensor 96 prior to the tripping of one or both of sensors 92, 94. In another embodiment, controller 38 increases the frequency at which audio sensor 96 is polled upon tripping of one of sensors 92, 94. In another embodiment, controller 38 continuously polls or receives signals from audio sensor 96 before and after tripping of sensors 92 and/or 94, but does not analyze such signals or compare such signals to stored audio signatures or stored jam threshold values per step 126 until one or both of sensors 92, 94 are tripped. As a result, processing time and processing power are conserved. In yet other embodiments, steps 122 and 124 may be omitted where controller 38 continuously or periodically senses and/or analyzes sound values from audio sensor 96. In such other embodiments, sensors and 92, 94 may be omitted.

As indicated by steps 126 and 128, controller 38 compares the sensed sound characteristics to one or more audio signatures indicative of a media jam. The sound characteristic being compared may comprise the actual digital or analog received signal from audio sensor 96 or may comprise another synthesized or generated value at least partially based upon the signals received from audio sensor 96. In one embodiment, controller 38 may compare a received sound characteristic equal to or corresponding to an amplitude of the sensed sound to a stored minimum sound amplitude characteristic that generally occurs when a media jam is beginning or taking place. As indicated by step 130, if the received or sensed sound meets or exceeds the stored sound amplitude threshold, controller 38 determines that a media jam is beginning or is in the process of being completed and controller 38 generates control signals adjusting the driving of the media. In another embodiment, in steps 128 and 130, controller 38 may compare sensed sound characteristics for a predetermined length or range of time with an audio signature of an ongoing media jam during a predetermined length or range of time. As indicated in step 130, if the sensed sound characteristics have a fingerprint or signature substantially similar to the fingerprint or signature of a media jam, controller 38 generates control signals adjusting the driving of media.

As indicated by step 132, once at least one of sensors 92 and 94 is tripped or triggered, controller 38 polls audio sensor 96 and compares such sensed sound characteristics for a predetermined time period. During the time period, if the sound characteristics do not sufficiently match or correspond to sound characteristics generally associated with a media jam, controller 38 returns to step 122, awaiting subsequent tripping or triggering of one or both of sensors 92, 94. In one embodiment, the predetermined time may correspond to a length of time consumed from tripping of a sensor 92 or 94 to driving of a leading edge of sheet through and beyond rollers 82, 84 or the time consumed from tripping of a sensor 92 or 94 to movement of a sheet through output 88. In embodiments where step 122 is omitted such that controller 38 continuously or periodically automatically polls or receives signals from audio sensor 96 and compares such signals to stored audio signatures, step 132 may also be omitted.

Steps 132, 134 and 136 illustrate various ways by which the driving of a sheet of media undergoing jamming (a portion of the sheet or medium being driven behind an obstructed portion of the same sheet or medium) may be adjusted automatically based on sensed sound while the same sheet is being driven to reduce severity of the jam. In step 132, rollers 64, 66 are moved apart from one another to separate the rollers. In particular, one or both of rollers 64, 66 may be driven away from the media being jammed. As a result, driving of the medium is stopped. In addition, separation of roller 64, 66 may further facilitate manual withdrawal of the medium, such as medium 100 shown in FIG. 1, from between rollers 64, 66 and rollers 82, 84.

As noted above, step 132 may be achieved by motor 74 being reversed so as to supply torque in a direction opposite to the direction which a medium is normally driven forward along the media path 54. In such an embodiment, the torque results in one or both of roller 64, 66 being moved away from the driven sheet. In one embodiment, transmission 70 or transmission 72 may have a similar configuration to that of a transmission used to drive pick tire 52 in a media advancing direction when torque is supplied in a first direction and to lift the pick tire from the media when torque is supplied in a second opposite direction. In yet another embodiment, one or both of rollers 64, 66 may be moved using one of more actuators 76, 78 (shown and described with respect to FIG. 1).

As indicated by step 134, transmissions 70, 72 may remain stationary and rollers 64, 66 may remain engaged with the media being driven and being jammed. However, motor 74 is reversed such that one or both of roller 64, 66 is driven in a reverse direction. As a result, the partially jammed sheet or medium is driven backwards along media path 54 towards an access region adjacent door 48. Consequently, manual withdrawal of the partially jammed media is further enhanced.

According to one embodiment, motor 74 is driven in a reverse direction which results in one or both of roller 64, 66 being driven in a reverse direction. In another embodiment, actuator 76 or actuator 78 may actuate transmission 70, 72 to a reversed state such that torque supplied by motor 74 and received by roller 64, 66 is in a reverse direction. For example, actuator 76, 78 may move an intermediate reversing gear (not shown) into coupling engagement with a gear train of transmission 70 or 72 to reverse the direction of the torque received by roller 64 or roller 66.

As indicated by step 136, rollers 64, 66 may remain in engagement with the sheet or medium being jammed, but the driving of the one or more rollers 64, 66 is terminated. For example, in one embodiment, motor 74 may be stopped. In another embodiment, motor 74 may be reversed, wherein transmission 70 or transition 72 is actuated to a non-transmitting state in response to receiving torque in the reversed direction. In another embodiment, one of both of actuator 76, 78 may actuate one or both of transmission 70, 72 to the non-transmitting state in which torque being provided by motor 74 is not transmitted to one or both of roller 64, 66.

As further indicated by FIG. 2, in particular instances, steps 132, 134 and 136 may be carried out in parallel or concurrently. For example, rollers 64 and 66 may initially be driven in a reversed direction to drive the medium through input 86 and to lesson compaction of any portion of the medium that has already been jammed. Rollers 64 and 66 may also be separated thereafter to facilitate manual withdrawal of the partially jammed medium. Likewise, steps and 132 and 136 may both be performed with step 132 being performed after performance of step 136. In particular environments, method 120 may initially include receiving commands via an input, such as a keyboard, keypad and the like, from a user selecting which particular step 132, 134, 136 or combination of such steps should be carried out to adjust media driving per step 130. In other embodiments, method 120 may include fewer of such media driving adjustment steps 132, 134 and 136.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A printer comprising:
an audio sensor configured to sense a medium being driven; and
a controller configured to compare audio signals received from the audio sensor with a stored audio signature representing a media jam to determine if a media jam is starting and to generate control signals adjusting driving of a medium being jammed prior to completion of the media jam.

2. The printer of claim 1 further comprising:
a pair of opposing rollers forming a nip, wherein at least one of the rollers is driven; and
an actuator, wherein the actuator is configured to separate the first pair of rollers to cease driving of the medium in response to the control signals.

3. The printer of claim 1 further comprising:
a pair of opposing rollers forming a nip, wherein at least one of the rollers is driven;
a motor; and
a transmission actuatable between a first transmitting state transmitting output of the motor to at least one roller and a second non-transmitting state, wherein the transmission actuates to the non-transmitting state in response to the control signals.

4. The printer of claim 1 further comprising:
a pair of opposing rollers forming a nip, wherein at least one of the rollers is driven; and
a motor configured to drive at least one roller, wherein the motor is configured to cease driving at least one roller in response to the control signals.

5. The printer of claim 1 further comprising:
a pair of opposing rollers forming a nip, wherein at least one of the rollers is driven; and
a motor configured to drive at least one roller, wherein the motor is configured to drive at least one roller in a reverse direction in response to the control signals.

6. The printer of claim 1 further comprising a pair of opposing rollers forming a nip, wherein at least one of the rollers is driven, wherein the first pair of opposing rollers includes a heated roller and a pressure roller.

7. The printer of claim 1 further comprising:
a first pair of opposing rollers forming a nip, wherein at least one of the rollers is driven; and
a second pair of rollers configured to drive the medium while the medium is being driven by the first pair of rollers.

8. The printer of claim 1 further comprising:
a pair of opposing rollers forming a nip, wherein at least one of the rollers is driven;
an enclosure at least partially enclosing the first pair of rollers and having an input, wherein the controller is configured to adjust driving of the medium prior to a trailing edge of the medium passing through the input.

9. The printer of claim 1 further comprising a pair of opposing rollers forming a nip, wherein at least one of the rollers is driven and wherein the controller is configured to adjust driving of the medium prior to a trailing edge of the medium passing through the nip.

10. The printer of claim 1 further comprising:
a pair of opposing rollers forming a nip, wherein at least one of the rollers is driven; and
a sensor configured to sense the medium after it has passed between the pair of rollers, wherein the controller is configured to adjust polling of the audio sensor or to begin comparing the audio signals received with the stored audio signature based upon signals from the sensor.

11. The printer of claim 1 further comprising:
a pair of opposing rollers forming a nip, wherein at least one of the rollers is driven;
a sensor configured to sense the medium prior to the medium reaching the nip, wherein the controller is configured to adjust polling of the audio sensor or to begin comparing the audio signals received with the stored audio signature based upon signals from the sensor.

12. A method comprising:
sensing sounds of a medium being driven; and
adjusting driving of the medium as the medium is being driven based on the sensed sounds.

13. The method of claim 12 further comprising comparing the sensed sounds to a stored sound signature, wherein adjusting of driving of the medium is based on the comparison.

14. The method of claim 12 further comprising driving the medium with a pair of rollers including at least one driven roller and moving at least one of the rollers to separate the pair of rollers based upon the sensed sounds.

15. The method of claim 12, wherein the adjusting comprises driving the medium in a reverse direction based upon the sensed sounds.

16. The method of claim 12, further comprising driving the medium with a pair of rollers including at least one driven roller, wherein the adjusting comprises ceasing driving of the least one driven roller.

17. The method of claim 12 further comprising driving the medium with a pair of rollers including at least one driven roller, wherein one of the rollers is heated.

18. The method of claim 12, wherein the medium is driven through an input of an enclosure and wherein the adjusting occurs prior to a trailing edge of the medium passing through the input.

19. The method of claim 12 further comprising driving the medium with a pair of rollers including at least one driven roller, wherein the adjusting occurs prior to a trailing edge of the medium passing through a nip of the pair of rollers.

20. A computer readable medium comprising instructions configured to direct one or more processors to:
compare sensed sound values of a medium being driven with stored sound signatures; and
generate control signals adjusting driving of the medium as the medium is being driven based on the sensed sound values.
